(19) United States
(12) Patent Application Publication
(10) Pub. No.: US 2016/0088857 A1
(43) Pub. Date: Mar. 31, 2016

(54) PASTE PREPARATION

(71) Applicant: LAPED DI PASTORELLO CLAUDIO E FABIO S.N.C., Ospedaletto Euganeo (IT)

(72) Inventor: Salvatore Cannavò, Rimini (IT)

(21) Appl. No.: 14/497,774

(22) Filed: Sep. 26, 2014

(51) Int. Cl. A23G 3/42; A23G 3/40

(52) U.S. Cl. CPC A23G 3/42; A23G 3/40

(57) ABSTRACT

Paste preparation for cake decorations; the preparation comprises: 43% to 47% by weight of erythritol; 24% to 28% by weight of isomalt; 14% to 17% by weight of a mixture of oligosaccharides of glucose; 4% to 6% by weight of at least one vegetable fat; and 4% to 8% by weight of water; the preparation experimentally showed rheological and organoleptic characteristics surprisingly similar to the traditional sugarpaste.

### TECHNICAL FIELD

The present invention relates to a paste preparation and a method for the manufacture of a paste preparation.

### BACKGROUND TO THE INVENTION

In the Anglo-Saxon world, cakes are often decorated with sugarpaste icing. The cakes are made of sponge masked in buttercream which, since it has low or zero humidity, provides an insulating layer which allows the sugarpaste to be spread over it without it absorbing humidity and therefore melting or tearing. This fashion has also spread to Europe over the last few years and has led to the creation of new professional figures: the cake designers.

Sugarpaste consists of at least 70% sugar (saccharose).

It is rare for a cake-maker to make the sugarpaste as it is cheaper and quicker to buy it.

In view of the increasingly high-calorie diet in the industrialised countries, low-calorie food is being constantly formulated, reducing the fat or sugar content.

Sugarpaste is one of those products in which these modifications are not simple because the type of product does not allow modification of the dry matter content and the characteristics of elasticity and gumminess do not allow a great variation in the ratio between the various ingredients. The products proposed so far therefore have a high calorie content and glycemic index.

The object of the present invention is to provide a paste preparation and a method for the manufacture of a paste preparation which overcome, at least partly, the drawbacks of the known art and are, at the same time, easy and inexpensive to produce and/or use.

### SUMMARY

According to the present invention, a paste preparation is provided and a method of manufacturing a paste preparation according to the following independent claims and, preferably, any one of the claims depending directly or indirectly on the independent claims.

### DETAILED DISCLOSURE

In accordance with a first aspect of the present invention, a paste preparation for confectionery decorations is provided. In particular, the preparation is adapted to be used for covering sponge cakes masked in buttercream.

The preparation comprises 40% (in particular, from 42%) to 55% (in particular, to 50%) by weight, relative to the overall weight of the preparation, of erythritol; 20% (in particular, from 22%) to 35% (in particular, to 32%) by weight, relative to the overall weight of the preparation, of at least one bulk sweetener; 8% (in particular, from 10%) to 20% (in particular, to 16%) by weight, with respect to the overall weight of the preparation, of at least one glucoside saccharide; and at least 1% (in particular, up to 10%) by weight, relative to the overall weight of the preparation, of at least one fat.

In particular, the glucoside saccharide is selected in the group consisting of glucose, maltose, one or more oligosaccharides of the glucose (and a combination thereof). More specifically, the glucoside saccharide is a mixture of glucose (more precisely, dextrose), maltose and oligosaccharides of glucose. Typically, the oligosaccharides are polymers of saccharides consisting of a number of saccharides up to 20.

In particular, the bulk sweetener has a calorie value lower than 3.2 Kcal/g and a sweetening power that is 40% higher than the sweetening power of saccharose.

It is important to point out that, although the sweetening power is subjectively variable, for each known sweetener the sweetening power is well defined and widely documented values exist. In the absence of documented values, it is nevertheless possible to evaluate the sweetening power by means of panel tests for comparison with sweeteners with known sweetening power (for example saccharose).

According to some embodiments, the bulk sweetener is (comprises a sweetener) selected in the group consisting of: sorbitol, mannitol, isomalt, maltitol, lactitol, xylitol and a combination thereof. More in particular, the bulk sweetener is selected in the group consisting of: isomalt, maltitol and a combination thereof. Advantageously, the bulk sweetener comprises (more precisely, is) isomalt.

The erythritol has a practically zero calorie value and glycemic and insulin indexes, a sweetening power of approximately 70% compared to saccharose, an organoleptic profile similar to saccharose, a high digestive tolerance and antiradical, anticarcinogenic and antiplaque activity.

Nevertheless, when consumed it produces a sensation of freshness on the palate.

In the present case, the bulk sweetener combines synergically with the erythritol so as to obtain a paste product with reduced calorie content and a flavour (in particular a sweetness) surprisingly similar to that of traditional sugarpaste.

It should be noted that the isomalt and the erythritol help to prevent tooth decay and slow down the formation of plaque. Their low glycemic index reduces sudden rises in blood glucose levels.

According to some embodiments, the preparation comprises 1% to (in particular, 2% to 4%) by weight, relative to the overall weight of the preparation, of fructose. The fructose further “rounds” the taste (it has a high sweetening power and a low glycemic impact).

According to specific embodiments, the preparation comprises 11% (in particular, 12%) to 15% (in particular, 14%) by weight, relative to the overall weight of the preparation, of glucoside saccharide.

It should be noted that the presence of the glucoside saccharide is very important, since it unexpectedly contributes significantly to the elasticity of the preparation. The glucoside saccharide also has the function of amalgamating the components and giving the preparation body.

Advantageously, the preparation comprises water. More precisely, the preparation comprises 2% (in particular, from 3%) to 11% (in particular, to 10%) by weight, relative to the overall weight of the preparation, of water. More precisely, the preparation comprises 4%(in particular, from 4.5%) to 9% (in particular, to 8%) by weight, relative to the overall weight of the preparation, of water.

The water cooperates with the glucoside saccharide to perform its functions.

Typically, the glucoside saccharide and the water are supplied as components of a glucose syrup.

The glucose syrup is normally defined as a purified concentrated aqueous solution of dietary saccharides (if necessary, with up to maximum 3% of other components), obtained (by means of hydrolysis) from starch/potato starch (and/or inulin) and having the following characteristics:

a) dry matter no less than 70% by weight;
b) equivalent dextrose no less than 20% by weight on the dry matter, expressed in D-glucose;
c) sulphated ash no more than 1% by weight on the dry matter.

According to specific embodiments (in addition or alternatively to the preceding ones), the preparation comprises 43% to 48% (in particular, to 47%) by weight, relative to the overall weight of the preparation, of erythritol.

According to specific embodiments (in addition or alternatively to the preceding ones), the preparation comprises 23% (in particular, from 24%) to 30% (in particular, to 28%) by weight, relative to the overall weight of the preparation, of at least one bulk sweetener.

According to specific embodiments (in addition or alternatively to the preceding ones), the preparation comprises 2% (in particular, from 3%) to 8% (in particular, to 6%) by weight, relative to the overall weight of the preparation, of at least one fat.

In some cases, the fat consists of one or more vegetable fats (i.e. originating from plant-based sources) and, in particular, is selected in the group consisting of: palm oil, palm kernel oil, cottonseed oil, safflower seed oil, sunflower oil, shea butter, illipe butter, cocoa butter, babassu oil, coconut oil (and a combination thereof). In specific cases, the fat is selected in the group consisting of: palm oil, cocoa butter, coconut oil (and a combination thereof).

Advantageously, the fat comprises cocoa butter (in particular, in combination with another vegetable fat like, for example, a fat obtained from palm and/or coconut-palm oil and/or coconut oil).

It should be noted that the presence of the fat is very important, since it contributes significantly to the elasticity and workability of the preparation.

According to some embodiments, the bulk sweetener is selected in the group consisting of: sorbitol, mannitol, isomalt, maltitol, lactitol, xylitol (and a combination thereof).

It is important to underline that the particular paste preparation of the present invention surprisingly has an extremely low calorie content and at the same time a good workability (since it is adapted to be used as a traditional sugarpaste).

Advantageously, the preparation furthermore comprises at least 0.1% (in particular, 0.2% to 2%) by weight, relative to the overall weight of the preparation, of starch. In some cases, the preparation furthermore comprises 0.4 (in particular, from 0.5%) to 1% by weight, relative to the overall weight of the preparation, of starch.

In particular, the starch is of vegetable origin, for example maize, potato and/or rice. In some specific cases, the starch comprises (is) rice starch.

It should be noted that the presence of starch is particularly advantageous if the melting point of the fat is relatively low.

The melting point of fatty acids is a function of the length of the chain and type of bond.

The temperature of the location where the cake-maker operates also affects the consistency and, therefore, the workability of the preparation. In fact, in a tropical climate, the preparation may not be workable due to poor consistency or seeping of the fat towards the outside; in a cold environment, on the other hand, the preparation may be so stiff as to make it difficult for the cake-maker to form a sheet to spread over the cake.

The composition of the fat must therefore be calibrated according to the area where the preparation will be used: countries with a tropical climate must have a mixture of fats with relatively high melting point, temperate climates a lower melting point and cold climates an even lower melting point. Usually the components of the fat defined above have melting points ranging from 30 to 34° C. for the cocoa butter up to 43-47C.° in the case of components of the fat such as fractionated or saturated fats.

The melting point of the fat is considered relatively low when it is below approximately 36° C. (in particular, around 32-34° C.). The melting point of the fat is considered relatively high when it is between 40° C. and 42° C. The melting point of the fat is considered medium around 36-38° C.

According to some preferred embodiments, the preparation comprises 0.2% (in particular, from 0.7%) to 5% (in particular, to 3%) by weight, relative to the overall weight of the preparation, of an emulsifier. Advantageously, the emulsifier is selected in the group consisting of glycerol, monoglycerides and diglycerides of fatty acids, sucrose esters, vegetable fibre (soluble), polydextrose (and a combination thereof). In particular, the emulsifier is selected in the group consisting of polydextrose, glycerol, vegetable fibre (soluble) (and a combination thereof). More precisely, the emulsifier is selected in the group consisting of glycerol, vegetable fibre (soluble) (and a combination thereof).

Advantageously, the emulsifier comprises (is) vegetable fibre (soluble). In particular, the vegetable fibre (soluble) content in the preparation is 0.1% (in particular, from 0.2%) to 3% (in particular, to 2%) by weight, relative to the overall weight of the preparation).

In particular, the vegetable fibre (soluble) is selected in the group consisting of: chicory fibre, bamboo fibre, cellulose, fibre obtained from legumes and/or cereals (and a combination thereof). According to some embodiments, the vegetable fibre (soluble) is selected in the group consisting of: oat fibre, chicory fibre, bamboo fibre, pea fibre, rice fibre, cellulose (and a combination thereof). More precisely, the vegetable fibre (soluble) is selected in the group consisting of: oat fibre, bamboo fibre, pea fibre (and a combination thereof). In some cases, the vegetable fibre (soluble) comprises (is) oat fibre.

It should be noted that the oat fibre has a reduced calorie content and has beneficial health effects due to the presence of beta-glucans.

According to some embodiments, the emulsifier comprises (is) glycerol. More precisely, the preparation comprises 0.3% (in particular, from 0.5%) to 1.5% (in particular, to 10%) by weight, relative to the overall weight of the preparation, of glycerol.

Advantageously, the preparation comprises 0.1% to 0.5% (in particular, to 0.3%) by weight, relative to the overall weight of the preparation, of an acid.

In particular, the acid is selected in the group consisting of: citric acid, isocitric acid, acetic acid, ascorbic acid, lactic acid, malic acid, tartaric acid (and a combination thereof). According to some embodiments, the acid is selected in the group consisting of: citric acid, acetic acid (and a combination thereof).

Alternatively or in addition to the above, advantageously, the preparation comprises 1% (in particular, from 2%) to 6% (in particular, to 6%) by weight, relative to the overall weight of the preparation, of at least one stabiliser, in particular selected in the group consisting of gum arabic, tragacanth gum, carboxymethyl cellulose (sodium salt), guar gum, tara gum, gellan gum, xanthan gum, konjac gum, carob flour, sodium alginate, agar agar, carrageenin, pectins (and a combination thereof). According to some embodiments, the stabiliser is chosen in particular in the group consisting of gum arabic, tragacanth gum, carboxymethyl cellulose (sodium salt) (and a combination thereof).

Alternatively or in addition to the above, advantageously, the preparation comprises a preservative. In particular, the preparation comprises 0.02% to 0.2% by weight, relative to the overall weight of the preparation, of the preservative. More precisely, the preservative is selected in the group consisting of: derivative of sorbic acid (e.g. potassium sorbate or sorbic acid itself), derivative of ascorbic acid (e.g. ascorbic acid itself), derivative of acetic acid (e.g. acetic acid itself), derivative of benzoic acid (e.g. sodium benzoate, paraoxybenzoate, parahydroxybenzoate—PHB—or benzoic acid itself) (and a combination thereof).

Alternatively or in addition to the above, advantageously, the preparation comprises at least one flavouring. According to some embodiments, the preparation comprises 0.01% (in particular, from 0.02%) to 1% (in particular, to 0.2%) by weight, relative to the overall weight of the preparation, of the flavouring. The flavouring can be of any type and, for example, chosen from pastry cream flavouring, vanilla flavouring, lemon (peel) flavouring and a combination thereof.

Alternatively or in addition to the above, advantageously, the preparation comprises at least one colouring agent. The colouring agent can be chosen according to the colour to be given to the preparation (e.g. titanium oxide for white).

According to some embodiments, the preparation is obtainable (or is obtained) by means of a method as described below according to a second aspect of the present invention.

In accordance with a second aspect of the present invention, a method is provided for the production of a paste preparation for cake decorations. More precisely, the preparation is adapted to be used for covering cakes, sponge masked in buttercream. In particular, the preparation is as defined in accordance with the first aspect of the present invention.

The method combines the following components: 40% (in particular, from 42%) to 55% (in particular, to 50%) by weight, relative to the overall weight of the preparation, of erythritol; 20% (in particular, from 22%) to 35% (in particular, to 32%) by weight, relative to the overall weight of the preparation, of at least one bulk sweetener; 10% (in particular, from 12%) to 25% (in particular, to 20%) by weight, relative to the overall weight of the preparation, of glucose syrup; and at least 1% (in particular, up to 10%) by weight, relative to the overall weight of the preparation, of at least one fat.

According to specific embodiments, 13% (in particular, from 14%) to 19% (in particular, to 17%) by weight, relative to the overall weight of the preparation, of the glucose syrup is used.

According to specific embodiments (in addition or alternatively to the preceding ones), 43% to 48% (in particular, to 47%) by weight, relative to the overall weight of the preparation, of erythritol is used.

According to specific embodiments (in addition or alternatively to the preceding ones), 23% (in particular, from 24%) to 30% (in particular, to 28%) by weight, relative to the overall weight of the preparation, of the bulk sweetener is used.

According to specific embodiments (in addition or alternatively to the preceding ones), 2% (in particular, from 3%) to 8% (in particular, to 6%) by weight, relative to the overall weight of the preparation, of the fat is used.

Advantageously, as a further component, at least 0.1% (in particular, 0.2% to 2%) by weight, relative to the overall weight of the preparation, of starch is combined with the others. In some cases, 0.4 (in particular, from 0.5%) to 1% by weight, relative to the overall weight of the preparation, of starch is used.

According to some preferred embodiments, as a further component, 0.2% (in particular, 0.7%) to 5% (in particular, 3%) by weight, relative to the overall weight of the preparation, of at least one emulsifier is combined with the others.

Advantageously, as a further component, 0.1% to 0.5% (in particular, to 0.3%) by weight, relative to the overall weight of the preparation, of at least one acid is combined with the others.

Alternatively or in addition to the above, advantageously, as a further component, 1% (in particular, from 2%) to 6% (in particular, to 6%) by weight, relative to the overall weight of the preparation, of at least one stabiliser is combined with the others.

Alternatively or in addition to the above, advantageously, as a further component, at least one preservative is combined with the others.

Alternatively or in addition to the above, advantageously, as a further component, at least one flavouring is combined with the others.

Alternatively or in addition to the above, advantageously, as a further component, at least one colouring agent is combined with the others.

Alternatively or in addition to the above, advantageously, as a further component, water is combined with the others. More precisely, 1% (in particular, from 2.5%) to 5% (in particular to 3%) by weight, relative to the overall weight of the preparation, of water is combined.

Alternatively or in addition to the above, advantageously, as a further component, 1% to 6% (in particular, 2% to 4%) by weight, relative to the overall weight of the preparation, of fructose is combined with the others.

According to some embodiments, each component independently of the others is defined according to the indications of the first aspect of the present invention.

According to some preferred embodiments, the method comprises a first mixing step, during which glucose syrup and the fat (and if necessary the thickener, the emulsifier, the acid and/or the stabiliser) are mixed while heating (in particular, up to 80° C.) so as to obtain an emulsion; and a second mixing step (which is at least partially subsequent to the first mixing step) during which the erythritol in powder, the bulk sweetener in powder (and if necessary the starch in powder) (and if necessary the fructose in powder) are mixed together with the emulsion.

In particular, the water is mixed with the glucose syrup and the fat (and if necessary a thickener, an emulsifier, an acid, a stabiliser and/or water) during the first mixing step.

Advantageously (but not necessarily), the powders consist of particles with size (or diameter) smaller than 100 μm (in particular, smaller than 90 μm). In particular, the powders consist of particles with size (or diameter) greater than 70 μm. More precisely, the powders have size (or diameter) of approximately 80 μm to 90 μm.

The sizes are obtained by means of successive screening with sieves with holes of decreasing size (diameters). The diameter of the holes of the first sieve which does not allow passage of the particles indicates the size (or diameter) of the particles.

The measurements by means of successive screening are taken for as long as the size (or diameters) of the particles and sieve holes allow (in particular, up to a minimum of 0.05 mm). Below this size (in particular, 0.05 mm), the sizes of the particles are measured as a mean diameter D (v,0.5) by means of a laser granulometer—in particular, using a laser granulometer Mastersizer Microplus Ver.2.19 (Malvern Instruments® Ltd).

The use of a granulometry as defined above is particularly advantageous as the preparation (in paste), once laid, must be smooth, homogeneous and with very fine grain. Clogging with lumps or crystals could cause the paste to tear, annulling the masking effect.

In particular, the method comprises a grinding step (prior to the first mixing step), during which the erythritol and the bulk sweetener (and if necessary the fructose) are ground until reaching the size indicated above. Advantageously, the grinding step is performed at controlled temperature and humidity (in particular, using a mill with fine mesh).

This reduces the risk of melting of the erythritol (which has a melting temperature of approximately 120° C.) and the bulk sweetener (the isomalt has a melting temperature of approximately 140° C.)

Advantageously, during the first mixing step the glucose syrup, the fat (and if necessary the thickener, the emulsifier, the acid and/or the stabiliser) are mixed so that when the mixing is interrupted, oil does not come up to the surface (i.e. the emulsion becomes stable).

In particular, by means of the second mixing step a homogeneous mixture is obtained.

Where also the preservative (e.g. potassium sorbate) and/or the colouring agent (e.g. titanium oxide) are used, they are dissolved in the above-mentioned water before the first mixing step and mixed together with the glucose syrup and the fat (and if necessary the thickener, the emulsifier, the acid and/or the stabiliser) during the first mixing step.

According to specific embodiments, during the first mixing step, glucose syrup, the thickener, the fat, the emulsifier, the acid, the preservative and the colouring agent are placed in a mixer (in particular a pasteurizer provided with emulsifier) in the above order.

According to some embodiments, the method is for the production of the preparation as described according to the first aspect of the present invention.

The preparation obtained with the method of the present invention has experimentally shown important and surprising advantages with respect to the state of the art. In particular, the preparation is extremely similar (in terms of both organoleptic and rheological characteristics) to the traditional sugarpaste and at the same time has extremely low calorie value and glycemic and insulin indexes.

Further characteristics of the present invention will become clear from the following description of a merely illustrative and non-limiting example.

### Example 1

A preparation was made having the composition shown in table 1.

TABLE 1

| | | Quantity (% by weight |
|---|---|---|
| | Producer (PR) | out of overall weight |
| Ingredient | Distributor (DS) | of preparation) |
| Isomalt | Cargill (PR and | 26 |
| (C*IsoMaltidex 16502) | DS) | |
| Erythritol | Cargill (PR and | 45 |
| (Zerose ™ 16959) | DS) | |
| Glucose syrup | Cargill (PR and | 15 |
| (C*Sweet M 01521) | DS) | |
| Mixture of fats | Eulip (PR and DS) | 5 |
| (SF/25 and cocoa | | |
| butter in a ratio ⅔) | | |
| Water | | 2.8 |
| Rice starch | Remy (PR) | 1 |
| Fiore C | Adea (DS) | |
| Oat fibre | Tate & Lyle (PR) | 1 |
| (Promoat betaglucan) | Abs Food (DS) | |
| Gum arabic | Agrigum (PR) | 3 |
| (Agri-Rapid Acacia R) | Natural World DS) | |
| Glycerol | Brenntag (PR e DS) | 1 |
| (Glycerin 99.7%) | | |
| Citric acid | Jungbunzlauer(PR) | 0.2 |
| | Bettella (DS) | |
| Titanium dioxide | Fiorio (PR and DS) | traces |

| | |
|---|---|
| Total | 100 |

The erythritol and the isomalt were ground separately so as to obtain particles with size of 80-90 μm, ensuring that these sweeteners did not melt. For this purpose a fine-mesh mill was used and a particular process was carried out with controlled temperature and humidity.

Glucose syrup, thickeners, fats, oat fibre, glycerol, citric acid, potassium sorbate and titanium dioxide were placed, in the above order, in a pasteurizer equipped with emulsifier. The citric acid, the titanium dioxide and the potassium sorbate had been previously dissolved in water. Emulsification was performed, heating up to 80° C. until the emulsion became stable, i.e. until when, once the process had stopped, oil did not come up to the surface and the compound tended to easily detach from the walls (a stable emulsion was obtained).

In a planetary mixer, the remaining powders (sweeteners and starch) were mixed together with the emulsion and the flavourings until obtaining complete homogeneity of the mixture.

The preparation obtained showed workability and usability surprisingly similar to the standard sugarpaste. It should furthermore be noted that the preparation obtained has a calorie content and glycemic index considerably lower than those of the traditional sugarpaste. Working with a manual rolling pin or semi-automatic dough sheeter, the characteristics of the preparation allow a very fine sheet (up to 1-2 mm thick) to be obtained, which can cover a sponge cake masked in buttercream, following the contours and without tearing in any way.

1. A paste preparation for confectionery decorations, the preparation comprising 40% to 55% by weight, relative to an overall weight of the preparation, of erythritol; 20% to 35% by weight, relative to the overall weight of the preparation, of at least one bulk sweetener; 8% to 20% by weight, relative to the overall weight of the preparation, of a glucoside saccharide, which is selected in the group consisting of glucose, maltose, one or more oligosaccharides of glucose, and a combination thereof; and 1% to 10% by weight, relative to the overall weight of the preparation, of at least one fat.

2. A preparation according to claim 1, wherein said fat is selected in the group consisting of: palm oil, palm kernel oil, cottonseed oil, safflower seed oil, sunflower oil, shea butter, illipe butter, cocoa butter, babassu oil, coconut oil, and a combination thereof; the preparation comprising, furthermore, 2% to 11% by weight, relative to the overall weight of the preparation, of water.

3. A preparation according to claim 1, wherein the bulk sweetener is selected in the group consisting of: sorbitol, mannitol, isomalt, maltitol, lactitol, xylitol, and a combination thereof; the preparation comprising, furthermore, 0.1% to 2% by weight, relative to the overall weight of the preparation, of starch.

4. A preparation according to claim 1 and comprising 42% to 50% by weight, relative to the overall weight of the preparation, of erythritol; 22% to 32% by weight, relative to the overall weight of the preparation, of the bulk sweetener; 10% to 16% by weight, relative to the overall weight of the preparation, of the glucoside saccharide; 3% to 8% by weight, relative to the overall weight of the preparation, of the fat; 0.2% to 2% by weight, relative to the overall weight of the preparation, of the starch; and 4% to 9% by weight, relative to the overall weight of the preparation, of water.

5. A preparation according to claim 1 and comprising 0.2% to 5% by weight, relative to the overall weight of the preparation, of an emulsifier.

6. A preparation according to claim 5, in which the emulsifier is selected in the group consisting of glycerol, monoglycerides and diglycerides of dietary fatty acids, sucrose esters, vegetable fibre, polydextrose, and a combination thereof.

7. A preparation according to claim 1 and comprising 0.5% to 4% by weight, relative to the overall weight of the preparation, of an emulsifier; the emulsifier is selected in the group consisting of glycerol, vegetable fibre, polydextrose and a combination thereof.

8. A preparation according to claim 1 and comprising 0.1% to 0.5% by weight, relative to the overall weight of the preparation, of an acid selected from citric acid, isocitric acid, acetic acid, ascorbic acid, lactic acid, malic acid, tartaric acid, and a combination thereof; and 1% to 6% by weight, relative to the overall weight of the preparation, of a stabilizer, selected in the group consisting of gum arabic, tragacanth gum, carboxymethyl cellulose (sodium salt), guar gum, tara gum, gellan gum, xanthan gum, konjac gum, carob flour, sodium alginate, agar, carrageenin, pectins, and a combination thereof.

9. A method of manufacturing a paste preparation for decorations according to claim 1; the method comprises combining the following components: 40% to 55% by weight, relative to the overall weight of the preparation, of erythritol; 20% to 35% by weight, relative to the overall weight of the preparation, of at least one bulk sweetener; 10% to 25% by weight, relative to the overall weight of the preparation, of glucose syrup; and 1% to 10% by weight, relative to the overall weight of the preparation, of at least one fat.

10. A method according to claim 9, wherein said fat is selected in the group consisting of: palm oil, palm kernel oil, cottonseed oil, safflower seed oil, sunflower oil, shea butter, illipe butter, cocoa butter, babassu oil, coconut oil, and a combination thereof; the method combining, furthermore, 2% to 11% by weight, relative to the overall weight of the preparation, of water.

11. Method according to claim 9, wherein the bulk sweetener is selected in the group consisting of: sorbitol, mannitol, isomalt, maltitol, lactitol, xylitol, and a combination thereof; the method combining, furthermore, 0.1% to 2% by weight, relative to the overall weight of the preparation, of starch.

12. Method according to claim 9, combining 42% to 50% by weight, relative to the overall weight of the preparation, of erythritol; 22% to 32% by weight, relative to the overall weight of the preparation, of the bulk sweetener; 10% to 16% by weight, relative to the overall weight of the preparation, of the glucoside saccharide; 3% to 8% by weight, relative to the overall weight of the preparation, of the fat; 0.2% to 2% by weight, relative to the overall weight of the preparation, of the starch; and 4% to 9% by weight, relative to the overall weight of the preparation, of water.

13. Method according to claim 9, combining, furthermore, 0.2% to 5% by weight, relative to the overall weight of the preparation, of an emulsifier.

14. Method according to claim 13, wherein the emulsifier is selected in the group consisting of glycerol, vegetable fibre (soluble), polydextrose (and a combination thereof).

15. Method according to claim 9, combining, furthermore, 0.1% to 0.5% by weight, relative to the overall weight of the preparation, of an acid chosen from citric acid, isocitric acid, acetic acid, ascorbic acid, lactic acid, malic acid, tartaric acid, and a combination thereof; and 1% to 6% by weight, relative to the overall weight of the preparation, of a stabilizer, selected in the group consisting of gum arabic, tragacanth gum, carboxymethyl cellulose (sodium salt), guar gum, tara gum, gellan gum, xanthan gum, konjac gum, carob flour, sodium alginate, agar, carrageenin, pectins, and a combination thereof.

16. Method according to claim 9, and comprising a first mixing step, during which the glucose syrup and the fat are mixed and heated (in particular, up to 80° C.) so as to obtain an emulsion; and a second mixing step, which is at least partially subsequent to the first mixing step and during which erythritol in powder and the bulk sweetener in powder are mixed together with the emulsion; the powders consist of particles with a size (namely diameter) that is smaller than 100 μm (in particular, smaller than 90 μm).

17. Method according to claim 16, wherein, during the first mixing step, 2% to 11% by weight, relative to the overall weight of the preparation, of water is also mixed together with the glucose syrup and the fat; during the second mixing step, 0.1% to 2% by weight, relative to the overall weight of the preparation, of starch is also mixed together with the erythritol in powder and the bulk sweetener in powder.

18. Method according to claim 16, wherein, during the first mixing step, the glucose syrup and the fat are mixed in such a way that, when the mixing is interrupted, oil does not come up to the surface (which means that the emulsion becomes stable); by means of the second mixing step, an homogeneous mixture is obtained; the powders consist of particles with a size (i.e. diameter) that is greater than 70 μm.
